(19) United States
(12) Patent Application Publication
(10) Pub. No.: US 2023/0353758 A1
(43) Pub. Date: Nov. 2, 2023

(54) SYSTEM AND METHOD FOR CONVERTING RAW RGB FRAMES TO VIDEO FILE

(71) Applicant: Dell Products L.P., Round Rock, TX (US)

(72) Inventors: JITENDRA KUMAR, Bangalor (IN); SOOREJ PONNANDI, Bangalore (IN); RAJESHKUMAR ICHCHHUBHAI PATEL, Bangalore (IN); MOHANA MURALI GURRAM, Bangalore (IN); B. BALAJI SINGH, BENGALURU (IN)

(21) Appl. No.: 17/661,210

(22) Filed: Apr. 28, 2022

(51) Int. Cl. H04N 19/172; G09G 5/00; G09G 5/06; G09G 5/36

(52) U.S. Cl. CPC H04N 19/172; G09G 5/006; G09G 5/06; G09G 5/363; G09G 2360/127; G09G 2340/125

(57) ABSTRACT

A system and method for converting raw frame data to a video file. Instead of converting all raw frame raw for each frame, embodiments create a mapping table and compare a mapping of the raw frame data for a current frame with a mapping of the raw frame data for a previous frame to determine if raw frame data changed from a previous frame to the current frame. Embodiments convert only the new raw frame data and update the mapping table with the new raw frame data, whereby the processing resources and time needed to convert raw frame data into a video file may be greatly reduced.

### BACKGROUND

### Field of the Disclosure

This disclosure relates generally to information handling systems and, more particularly, to systems and methods for conversion of raw frame data into a viewable video file.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may experience a boot failure or a crash. As part of an analysis, raw frame data corresponding to visual information may be captured and converted to a video file to enable a technician to review events leading up to the boot failure or system crash.

### SUMMARY

Embodiments may be generally directed to a method for converting raw frame data to a video file. The method may start with receiving raw frame data for a plurality of frames from a host display. Converting the raw frame data for a first frame comprises converting raw frame data for the frame to a second data format and converting the frame data in the second data format to a video frame in a video frame format. Converting the raw frame data for each subsequent frame comprises determining any new raw frame data for the current frame, converting the new frame data to the second data format, converting the new frame data and the unchanged frame data for the previous frame to a video frame in the video frame format, and combining the video frame for the first frame and the video frame for each subsequent frame into a video file.

In some embodiments, the raw frame data format is in an RGB format. In some embodiments, the second format comprises a YUV file format. In some embodiments, the video file comprises a Moving Picture Experts Group (MPEG) file.

In some embodiments, determining new raw frame data comprises creating a mapping table and mapping the raw frame data for the first frame to a mapping table and for each subsequent frame, comparing the raw frame data with the mapped frame data. In some embodiments, comparing raw frame data for a current frame with raw frame data for a previous frame comprises comparing a mapping of the raw frame data for a current frame with a mapping of raw frame data for a previous frame. In some embodiments, comparing raw frame data for a current frame with raw frame data for a previous frame comprises determining the new raw frame data comprises less than 50%, less than 20% or less than 10% of the raw frame data of a full frame.

In some embodiments, the raw frame data is received from a host display in response to a failure.

Embodiments may also be generally directed to a system for converting raw frame data for a plurality of frames of visual information related to operation of an information handling system. The system comprises a video graphics array (VGA) core for communicating with a host display configured to display visual information and a controller storing instructions that, when executed by a processor, cause the processor to convert raw frame data to a video file. The controller executes the instructions to receive raw frame data for a plurality of frames from the host display. For a first frame, the processor converts the raw frame data for the frame to a second data format and converts the frame data in the second data format to a video frame in a video frame format. For each subsequent frame, the processor compares raw frame data for a current frame with raw frame data for a previous frame to determine a first portion of unchanged frame data and a second portion of new raw frame data, converts the new raw frame data to the second data format, converts the new raw frame data and the unchanged frame data for the previous frame to a video frame in the video frame format, and combines the video frame for the first frame and the video frames for each subsequent frame into a video file.

In some embodiments, the controller comprises a mapping table, wherein the instructions, when executed by the processor, cause the processor to map the raw frame data for the first frame to the mapping table and, for each subsequent frame, compare the raw frame data with raw frame data stored in the mapping table to determine the first portion of unchanged frame data and the second portion of new frame data and update the region of the mapping table with the new raw frame data.

In some embodiments, the raw frame data received from the host display is in an RGB format. In some embodiments, the second format comprises a YUV format. In some embodiments, the video file comprises a Moving Picture Experts Group (MPEG) file.

In some embodiments, the processor executes the instructions in response to receiving a signal indicating one of a boot failure or a crash capture. In some embodiments, the visual information comprises a background color, an application running on the information handling system, a mouse position and a clock display, wherein the second portion of modified frame data comprises one or more of a change in the background color, the application, the mouse position and the clock display.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram of selected components of an information handling system;

FIG. 2 is a flow diagram of selected steps in a typical boot crash capture process, illustrating a method for converting raw frame data for full frames to a video file; and

FIG. 3 is a flow diagram of selected steps in a boot crash capture process in accordance with one embodiment, illustrating a method for converting raw frame data for frames to a video file.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

As used herein, a hyphenated form of a reference numeral refers to a specific instance of an element and the un-hyphenated form of the reference numeral refers to the collective or generic element. Thus, for example, widget “72-1” refers to an instance of a widget class, which may be referred to collectively as widgets “72” and any one of which may be referred to generically as a widget “72.”

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a laptop, a tablet, a 2-in-1, or another device and may vary in size, shape, performance, functionality, and price. The information handling system includes volatile and persistent memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such wires, optical fibers, microwaves, radio waves, and other electromagnetic and/or optical carriers; and/or any combination of the foregoing.

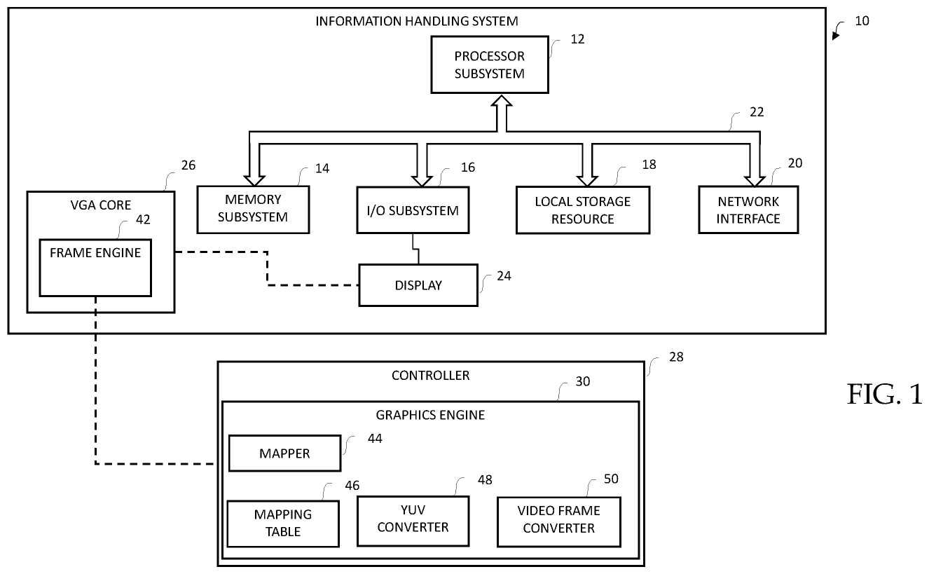

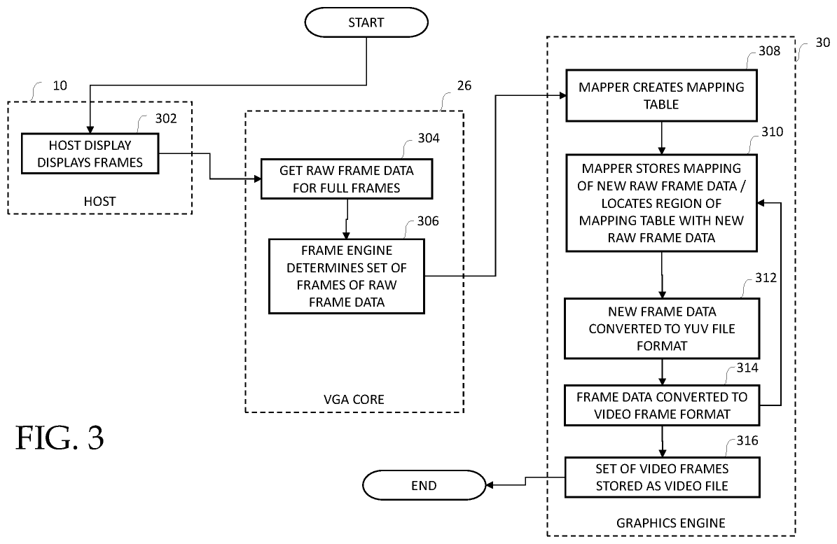

Particular embodiments are best understood by reference to FIGS. 1-3 wherein like numbers are used to indicate like and corresponding parts.

FIG. 1 illustrates a block diagram depicting selected elements of an embodiment of information handling system 100. As described herein, information handling system 100 may represent a personal computing device, such as a personal computer system, a desktop computer, a laptop computer, a notebook computer, etc., operated by a user. In various embodiments, information handling system 100 may be operated by the user using a keyboard and a mouse (not shown).

As shown in FIG. 1, components of information handling system 10 may include, but are not limited to, processor subsystem 12, which may comprise one or more processors, and system bus 22 that communicatively couples various system components to processor subsystem 12 including, for example, a memory subsystem 14, an I/O subsystem 16 and local storage resource 18. Information handling system 10 may be communicatively coupled to controller 28 comprising mapper 44, mapping table 46, YUV converter 48 and video frame converter 50, discussed in greater detail below.

Processor subsystem 12 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 12 may interpret and/or execute program instructions and/or process data stored locally (e.g., in memory subsystem 14).

System bus 22 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In information handling system 100, I/O subsystem 16 may comprise a system, device, or apparatus generally operable to receive and transmit data to or from or within information handling system 100. I/O subsystem 16 may represent, for example, a variety of communication interfaces, graphics interfaces, video interfaces, user input interfaces, and peripheral interfaces. In various embodiments, I/O subsystem 16 may be used to support various peripheral devices, such as a touch panel, a display adapter, a keyboard, an accelerometer, a touch pad, a gyroscope, or a camera, among other examples. In some implementations, I/O subsystem 16 may support so-called ‘plug and play’ connectivity to external devices, in which the external devices may be added or removed while portable information handling system 100 is operating. I/O subsystem 16 may include or communicate with display 24 for presenting visual information to a user.

In FIG. 1, local storage resource 18 may comprise computer-readable media (e.g., hard disk drive, floppy disk drive, CD-ROM, and other type of rotating storage media, flash memory, EEPROM, or another type of solid state storage media) and may be generally operable to store instructions and data, and to permit access to stored instructions and data on demand. One or more computer-readable media may be utilized for persistent memory.

In FIG. 1, network interface 20 may be a suitable system, apparatus, or device operable to serve as an interface between information handling system 100 and a network (not shown). Network interface 20 may enable information handling system 100 to communicate over the network using a suitable transmission protocol and/or standard, including, but not limited to, transmission protocols and/or standards enumerated below with respect to the discussion of the network. In some embodiments, network interface 20 may be communicatively coupled via the network to a network storage resource (not shown). The network coupled to network interface 20 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 20 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 20 and/or various components associated therewith may be implemented using hardware, software, or any combination thereof.

Video Capture Associated with System Failure

During operation of information handling system 10, controller 28 monitors information handling system 10. Controller 28 may be an embedded controller (EC) or a remote access controller (RAC). Controller 28 may receive an indication of an event such as a boot failure or an operating system (OS) crash. If there is an event, controller 28 records raw frame data for analysis, including video analysis of a host video. For example, an iDRAC Keyboard Video and Mouse (KVM) solution can capture raw frame data for a host boot video corresponding to an Operating System (OS) crash. During this video capture, controller 28 obtains raw frame data for each frame of the host video. In some embodiments, VGA core 26 communicates with display 24 to get raw frame data. In some embodiments, frame engine 42 identifies each frame in a set of frames associated with the host video. The raw frame data for each frame is converted and forms part of a video file.

Raw frame data for each frame may the same or different from a preceding frame. For example, it is possible that the raw frame data for the Nth+1 frame is the same as raw frame data for the Nth frame, such as if the mouse position did not change, the clock display did not change, an application running on processor subsystem 12 did not change and the background color did not change. It is also possible that the raw frame data for the Nth+1 frame differs slightly from frame data for the Nth frame (e.g., because the mouse position changed or the time changed). A slight change may indicate less than 10% of the raw frame data for a current frame is different than the raw frame data for the previous frame. An application executing on information handling system 100 may result in the raw frame data for the Nth+1 frame differing less than 20% from raw frame data for the previous (Nth) frame (e.g., the application may cause host display 24 to display a spreadsheet in a new window). The raw frame data for a current (Nth+1) frame may differ completely from raw frame data for the previous (Nth) frame (e.g., because a video was displayed in full screen mode).

One common approach to converting raw frame data to a video file involves encoding raw frame data for each full frame to a YUV file format, converting the frame data to a video frame and combining all the frames into a video file before the video file is exported to storage.

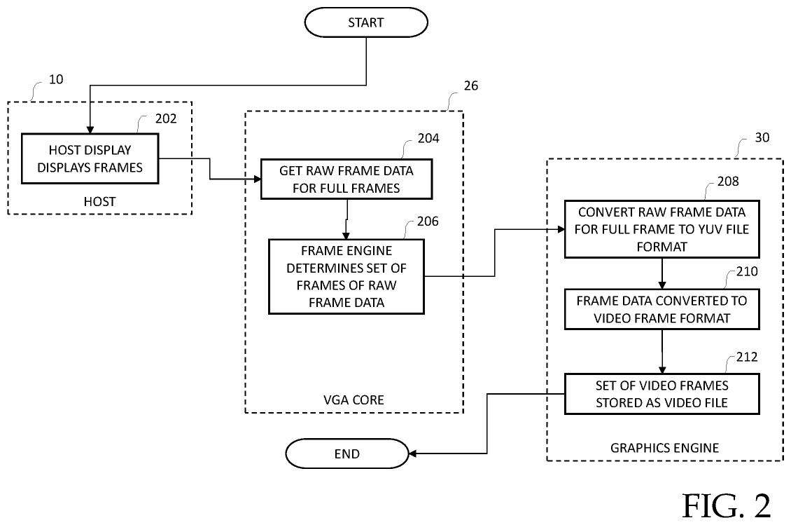

FIG. 2 depicts a flow diagram 200 of a typical method for converting captured raw frame data to a video file.

At step 202, host display 24 displays video frames in a first format.

At step 204, video graphics array (VGA) core 206 communicates with host display 24 to get raw frame data for a plurality of frames. The raw frame data may be in a raw frame data format such as red-green-blue (RGB) format.

At step 206, frame engine 42 (which may be hardware or software) gets the raw frame data or the plurality of video frames and determines a set of frames for converting raw frame data to a video file.

At step 208, graphics engine 30 converts the raw frame data for each full frame to a file format such as the YUV file format.

At step 210, graphics engine 30 executes instructions to convert the frame data in the second frame data format to a video frame. The video frame forms part of a set of video frames in a video file. Steps 208-210 are repeated until raw frame data for each full frame is converted into a set of video frames.

At step 212, graphics engine 30 executes instructions to store the set of video frames as a video file. The video file may be in a format such as a Moving Picture Experts Group (MPEG) file format.

This conversion process results in high CPU and memory resource allocation due to the conversion of all raw frame data for each full frame. In some scenarios, this can lead to an application respawn.

Embodiments overcome these shortcomings with a system and method for converting raw frame data that consumes raw frame data for portions of frames instead of converting raw frame data for each full frame. Embodiments may reduce the system resource usage with any BMC SoC independent of underlying software.

### Conversion of New or Changed Raw Frame Data for Each Frame

Embodiments reduce the processing power and time needed to convert raw frame data for a set of frames. Raw frame data for the first frame (e.g., N=1) is fully converted but serves as a basis for subsequent frames (e.g., N=2, N=3, N=4 . . . ). After the raw frame data is processed for a frame (e.g., the Nth frame), processing raw frame data for a subsequent frame (e.g., the Nth+1 frame) only requires processing raw frame data that has changed. Thus, raw frame data for subsequent full frames may not need to be fully processed. For example, if the only difference between a previous (an Nth frame) and a current frame (the Nth+1 frame) is the mouse position on the display 204, fully converting raw frame data for the background color, header information, etc., for the Nth+1 frame may be avoided or greatly reduced.

At step 302, host display 24 displays video frames in a first format.

At step 304, video graphics array (VGA) core 206 communicates with host display 24 to get raw frame data for a plurality of frames. The raw frame data may be in a raw frame data format such as red-green-blue (RGB) format.

At step 306, frame engine 42 (which may be hardware or software) gets the raw frame data or the plurality of video frames and determines a set of frames for converting raw frame data to a video file.

At step 308, a processor 44 executing a mapper function (which may be referred to as mapper 44) uses raw frame data for the first frame and creates a mapping table for mapping source data to a destination, which is the same as steps 202-214 described above.

For each subsequent frame after the first frame, at step 310, mapper 44 determines any regions of the mapping table containing raw frame data that has changed between the previous frame to the current frame. Mapper 44 may determine unchanged frame data and new frame data. Unchanged frame data corresponds to raw frame data that did not change. For example, the background color in the Nth frame may have been blue and the background color in the Nth+1 frame may have also been blue, so the raw frame data for the background color would be unchanged frame data. New raw frame data corresponds to raw frame data that changed. Examples of new raw frame data range from small changes such as a mouse position or clock display, partial display changes such as a window opening to display a new application or a window displaying new content up to a full-screen application displaying content (e.g., an application displaying a movie file in “full screen” mode). In each of these cases, at least some raw frame data comprises new frame data. In some embodiments, mapper 44 communicates with mapping table 46 to determine new frame data. Mapping table 46 may be a pixel row mapping table. For each subsequent frame after the first frame, mapper 44 may compare the raw frame data with the raw frame data stored in mapping table 46 to determine a first portion of the raw frame data as unchanged frame data and a second portion of the raw frame data as new frame data. In some embodiments, mapper 44 compares a mapping of the raw frame data with a mapping of the raw frame data for a previous frame to determine a region in mapping table 46 with unchanged raw frame data and a region in mapping table 46 with new raw frame data. Mapper 44 may update mapping table 46 to include new raw frame data for the current frame as raw frame data for a previous frame, wherein raw frame data for a subsequent frame may be compared against the raw frame data for the previous frame. In some embodiments, mapper 44 updates a region of mapping table 46 with a mapping of the new frame data, wherein a region of mapping table 46 corresponding to unchanged frame data does not need to be updated.

At step 312, new frame data is sent to a processor 48 that executes instructions to convert frame data from the first frame data format to a second frame data format. In some embodiments, the second frame data format is a YUV format and processor 48 may be referred to as YUV converter 48. Processor 48 does not need to convert raw frame data for a full frame unless the modified frame data comprises full frame data. In some embodiments, processor 48 converts the modified frame data and combines the modified frame data with unchanged frame data that was previously converted.

At step 314, the full frame data is converted to a video frame. In some embodiments, converting the full frame data for a frame comprises converting the combined new frame data and the unchanged frame data for a frame to a video frame. Steps 310-314 are repeated until raw frame data for each full frame in a plurality of frames is converted into a set of video frames. The video frames may be in a video file format such as a Moving Picture Experts Group (MPEG) file format.

At step 316, graphics engine 30 stores the set of frames as a video file. A technician may view the video file and see what visual information host display 24 was displaying when the event occurred, which may assist the technician in determining what caused information handling system to experience a failure. For example, a technician may view the video file and determine a user was dragging a large window across display 24.

Using this approach, if the difference in raw frame data between the Nth frame and the Nth+1 frame is 2%, embodiments may be able to process only 2% of the raw frame data, resulting in a large decrease in time or processing of the Nth+1 frame, but still providing an accurate video file of the event. Thus, the total time needed to convert the raw frame data to a video file depends not only on the number of frames but how much the raw frame data for each frame differs from the raw frame data for the immediately preceding frame.

Embodiments may greatly reduce the time needed to convert raw frame data to a video file. If a frame needs 100% conversion, embodiments need the same amount of time to convert raw frame data for the full frame. In some test cases, the time needed to convert raw frame data for a full frame may be about five seconds. However, as the amount of raw frame data that needs to be converted decreases, embodiments need less time to convert the raw frame data. In some test cases, the time needed to convert raw frame data for approximately 5% new raw frame data required less than one second. As the number of frames increase and the amount of content increases, the ability to convert only modified frame data may result in significant decreases in the processing time and processing resources needed to generate a video file associated with an event.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving raw frame data in a raw frame data format for a plurality of frames from a host display;
for a first frame of the plurality of frames:
converting the raw frame data for the first frame to frame data in a second data format; and
converting the frame data in the second data format to a video frame in a video frame format;
for each subsequent frame of the plurality of frames:
comparing raw frame data for a current frame with raw frame data for a previous frame to determine a first portion of the raw frame data as unchanged frame data and a second portion of the raw frame data as new raw frame data;
converting the new frame data to the second data format;
converting the new frame data in the second format and the unchanged frame data for the previous frame to a video frame in the video frame format; and
combining the video frame for the first frame and the video frame for each subsequent frame of the plurality of frames into a video file.

2. The method of claim 1, wherein the raw frame data format comprises a red-green-blue (RGB) format.

3. The method of claim 1, wherein the second data format comprises a YUV file format.

4. The method of claim 1, wherein the video file comprises a Moving Picture Experts Group (MPEG) file.

5. The method of claim 1, wherein comparing the raw frame data for the current frame with the raw frame data for the previous frame comprises:
creating a mapping table;
mapping the raw frame data for the first frame to the mapping table; and
for each subsequent frame:
determining a first region corresponding to unchanged raw frame data and a second region corresponding to new raw frame data; and
updating the second region of the mapping table with the new raw frame data for the current frame.

6. The method of claim 5, wherein comparing the raw frame data for the current frame with the raw frame data for the previous frame comprises determining the second region of the mapping table comprises less than 50% of the raw frame data.

7. The method of claim 5, wherein comparing the raw frame data for the current frame with the raw frame data for the previous frame comprises determining the second region of the mapping table comprises less than 20% of the raw frame data.

8. The method of claim 5, wherein comparing the raw frame data for the current frame with the raw frame data for the previous frame comprises determining the second region of the mapping table comprises less than 10% of the raw frame data.

9. The method of claim 1, wherein the raw frame data is received from a host display in response to a failure.

10. A system for converting raw frame data for a plurality of frames related to operation of an information handling system, the system comprising:
a video graphics array (VGA) core for communicating with a host display;
a controller storing instructions that, when executed by a processor, cause the processor to:
receive raw frame data for each frame of a plurality of frames from the host display;
for a first frame of the plurality of frames:
convert the raw frame data for the first frame from the raw frame data format to a second data format; and
convert the raw frame data in the second data format to a video frame in a video frame format;
for each subsequent frame of the plurality of frames:
compare raw frame data for a current frame with raw frame data for a previous frame to determine a first portion comprising unchanged frame data and a second portion comprising new frame data;
convert the new raw frame data to the second data format;
convert the new raw frame data and the unchanged raw frame data for the previous frame to a video frame in the video frame format; and
combine the video frame for the first frame and the video frame for each subsequent frame of the plurality of frames into a video file.

11. The system of claim 10, the controller further comprising a mapping table, wherein the instructions, when executed by the processor, cause the processor to:
create a mapping table;
map the raw frame data for the first frame to the mapping table; and
for each subsequent frame:
compare a mapping of the raw frame data for the current frame with a mapping of the raw frame data stored in the mapping table to determine a first region with unchanged raw frame data and a second region with new raw frame data; and
update the second region of the mapping table with the new raw frame data for the current frame.

12. The system of claim 10, wherein the raw frame data format comprises a red-green-blue (RGB) format.

13. The system of claim 10, wherein the second frame data format comprises a YUV file format.

14. The system of claim 10, wherein the video file comprises a Moving Picture Experts Group (MPEG) file.

15. The system of claim 10, wherein the processor executes the instructions in response to receiving a signal indicating one of a boot failure or a crash capture.

16. The system of claim 10, wherein the visual information comprises a background color, an application running on the information handling system, a mouse position and a clock display, wherein the second portion of modified frame data comprises one or more of a change in the background color, the application, the mouse position and the clock display.

17. An information handling system comprising:
a processor subsystem;
a host display for presenting visual information related to the operation of the information handling system; and
a system for converting raw frame data for a plurality of frames for analyzing events related to the operation of the information handling system, the system comprising:
a video graphics array (VGA) core for communicating with the host display configured to display visual information based on frame data for a plurality of frames; and
a controller storing instructions that, when executed by a processor, cause the processor to:
receive raw frame data for each frame of the plurality of frames from the host display;
for a first frame of the plurality of frames:
create a mapping table;
store a mapping of the raw frame data;
convert the raw frame data for the first frame from the raw frame data format to a second data format; and
convert the raw frame data in the second data format to a video frame in a video frame format;
for each subsequent frame of the plurality of frames:
determine a first region of the mapping table corresponds to a first portion of the raw frame data as unchanged raw frame data and a second region of the mapping table corresponds to a second portion of the raw frame data as new raw frame data;
convert the new raw frame data to the second data format;
convert the new raw frame data and the unchanged raw frame data for the previous frame to a video frame in the video frame format; and
combine the video frame for the first frame and the video frame for each subsequent frame of the plurality of frames into a video file.

18. The information handling system of claim 16, wherein the instructions, when executed by the processor, cause the processor to:
map the raw frame data for the first frame to the mapping table; and
for each subsequent frame:
compare a mapping of the raw frame data with a mapping of the raw frame data stored in the mapping table to determine the first portion of unchanged frame data and the second portion of new frame data; and
update the second region of the mapping table with a mapping of the new raw frame data for the current frame.

19. The information handling system of claim 16, wherein the raw frame data format comprises a red-green-blue (RGB) format.

20. The information handling system of claim 16, wherein the second format comprises a YUV file format.
